(19) United States
(12) Patent Application Publication
(10) Pub. No.: US 2004/0134189 A1
(43) Pub. Date: Jul. 15, 2004

(54) Computer monitored portable hydraulic power generation system

(76) Inventor: Alex L. Brigden, Quesnel (CA)

Correspondence Address: ALEX L. BRIGDEN, #4-101 SPEARS RD, QUESNEL, BC, V2J 4Z3, CA

(21) Appl. No.: 10/338,109

(22) Filed: Jan. 9, 2003

(51) Int. Cl. F16D 31/02

(52) U.S. Cl. 60/368

(57) ABSTRACT

A hydraulic power generation system which is monitored and controlled by means of a computer, with the ability to have said hydraulic power generation system's hydraulic characteristics and computer easily modified so as be completely customizeable, both in terms of operation and interface.

### FEDERALLY SPONSORED RESEARCH

Not Applicable

### SEQUENCE LISTING OR PROGRAM

Program listing for computer enclosed on compact disk in duplicate

### BACKGROUND—FIELD OF INVENTION

This invention relates to power generation systems—in particular, hydraulic power generaton systems controlled by a digital computer.

### BACKGROUND—DESCRIPTION OF PRIOR ART

In the field of hydraulic power generation systems, it has often been difficult to change the characteristics of the system.

Characteristics that have been difficult to change in the past include:

(a) Changing from an intermitent to a continuous flow application.

Intermitent operation in the context of the present invention is defined as having the electrical motor(s) in the system remain idle until needed to supply power to the hydraulic pump(s). This has the advantage of not forcing the motor(s) to run continuously, which keeps the system from potentially overheating or consuming unneeded power during idle periods.

Continuous operation in the context of the present invention is defined as having the electrical motor(s) in the system continuously running and therefore always able to immediately provide power to the hydraulic pump(s) in the system. This has the advantages of more responsive system control, removal of electrical motor startup spikes, and the capability for less expensive motors to be used.

The present invention can be easily switched between these two modes of operation via an external control communicating with the computer.

(b) High motor startup spikes.

Motor spikes become increasingly detrimental to the motor as a result of increasing load at the time of startup. The motor will draw considerably more power than normal in order to try and bring the motor to an acceptable rotation speed. This has the cumulative effect of creating inefficiency through heat loss, excessive power draw at motor startup, and eventually harm to the motor.

The present invention negates this problem by constantly monitoring the state of the motor(s), pump(s), and load(s) in the hydraulic system. Accordingly, a soft start—defined in the context of the present invention as a period of time wherein the motors are able to build up a higher rotational speed without being under load—is used, with the time duration of said soft start based on monitored values from the motor(s), pump(s) and load(s). This reduces power consumption during motor startup dramatically.

(c) Easily adjustable variable flow rate.

In the past, other hydraulic systems, such as U.S. Pat. No. 4,369,625 to Izumi/Hitachi, have often relied on expensive proportionally controlled hydraulic means to alter their flow rates. U.S. Pat. No. 5,735,506 to Warnan, achieves a variable flow rate through mechanically activated means, but is susceptible to oil viscosity.

In reference to the present invention, the flow rate is adjusted by means of a simplified network of valves. By activating different combinations of valves, the desired flow rate can be easily achieved. This is a more robust, simplified, and cost effective means of achieving flow rate adjustments.

In the context of the present invention, this simplified means of flow adjustment is referred to as “load sense”.

(d) Inability to easily adjust hydraulic behavior.

Previously, hydraulic power systems have lacked the ability to easily alter their behavior. The hydraulic fluid pressure settings, the motor and pump startup characteristics, power drain behavior, and switching between continuous and intermitent operation would all require major changes to the system, often requiring considerable downtime and expenses.

The present invention avoids these downfalls by being completely programmable and customizable by means of a computer control. Hydraulic, electronic, time and other variables can all be changed with ease to provide entirely different characteristics to the system. For example, power drain can be reduced by increasing the period of soft start or entering continuous operation mode, performance can be dramatically improved by simply altering load sense parameters, and completely different hydraulic power needs can be met simply by monitoring new inputs.

### OBJECTS AND ADVANTAGES

Besides and in addition to the objects and advantages over prior hydraulic power generation system described above, several objects and advantages of the current invention are:

(a) To provide a hydraulic power generation system with the capability to monitor any parameter of its operation—these may include, but are not limited to:

hydraulic fluid pressure

status of power source

status of valves

status of solenoid coils

temperature of system

level of hydraulic fluid

abnormalities or problems present in any stage of the hydraulic system

time;

(b) To provide a hydraulic power generation system with the ability to easily alter any aspect of said system, be it the behavior of the computer, a part of the hydraulic system itself, etc., to allow for flexible and easily modifiable hydraulic and electronic characteristics;

(c) To provide a hydraulic power generation system with the ability to adapt to any input means—such as but not limited to:

an operator controlled input device such as a control stick

a control panel provided on the hydraulic system itself

remote computer operation;

(d) To provide a hydraulic power generation system with the ability to adapt to a variety of different power sources;

(e) To provide a hydraulic power generation system which is portable and therefore easy to transport and maintain;

(f) To provide a hydraulic power generation system with the means to record and report the time said system has been in use;

(g) To provide a hydraulic power generation system with the capability to be adapted to its surroundings—physical size, structural integrity, weight, fastening means, and heat and noise characteristics are all modifiable to any requirements;

(h) To provide a hydraulic power generation system which encapsulates and hides the complex behavior of an advanced hydraulic system with a simple interface;

(i) To provide a hydraulic power generation system which is adaptable to a variety of different applications.

Further objects and advantages will become apparent in the insuing description and drawings.

### SUMMARY

The present invention consists of a hydraulic power generation system which is monitored and controlled by means of a computer, with the ability to have said hydraulic power generation system's hydraulic characteristics and computer easily modified so as be completely customizeable, both in terms of operation and interface.

### DRAWINGS

### Drawing Figures

In the drawings, different views of the same part have the same number but different alphabetic suffixes.

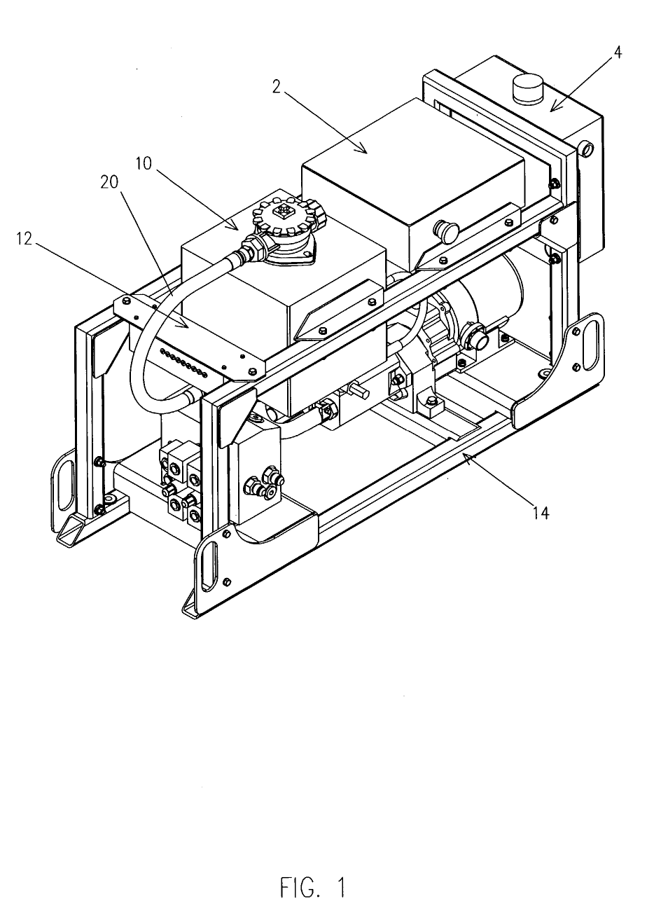

FIG. 1 shows a complete isometric view of a preferred embodiment of the present invention.

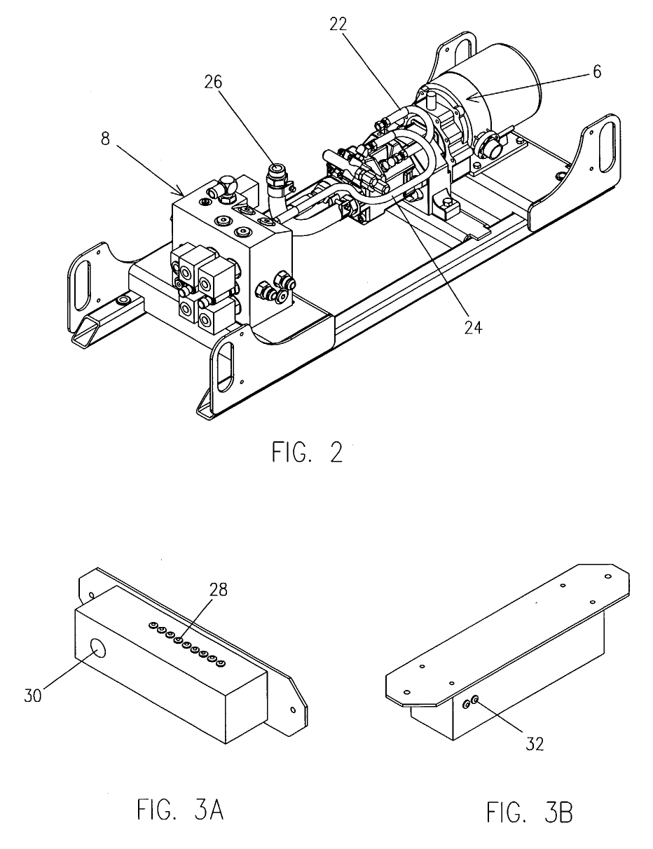

FIG. 2 shows an isometric view of the same embodiment of said present invention as FIG. 1 with the top components (main power enclosure, hydraulic fluid reservoir, electric junction enclosure, and control panel) and top half of the support structure removed for clarity.

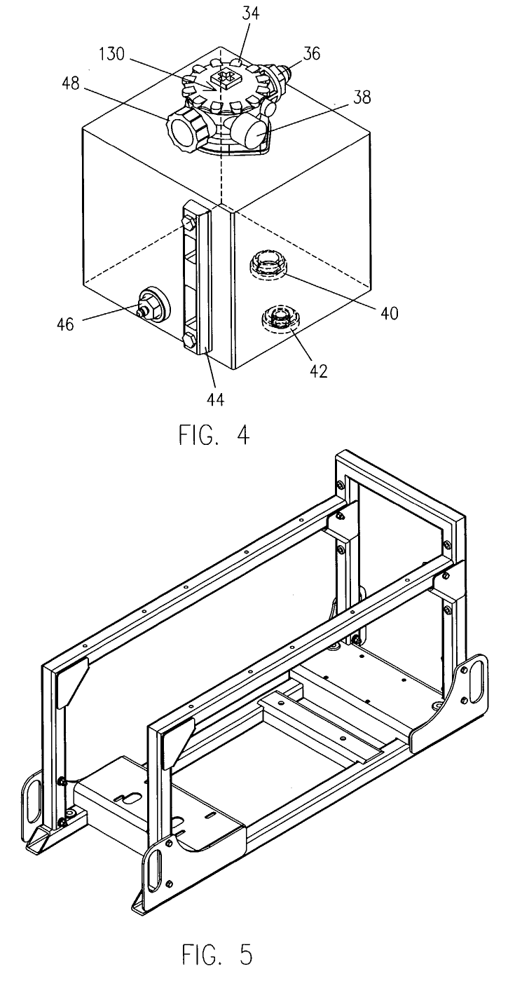

FIGS. 3A and 3B show two different isometric views of the electric junction enclosure.

FIG. 4 shows an isometric view of the hydraulic fluid reservoir.

FIG. 5 shows an isometric view of the support structure with all the other components removed.

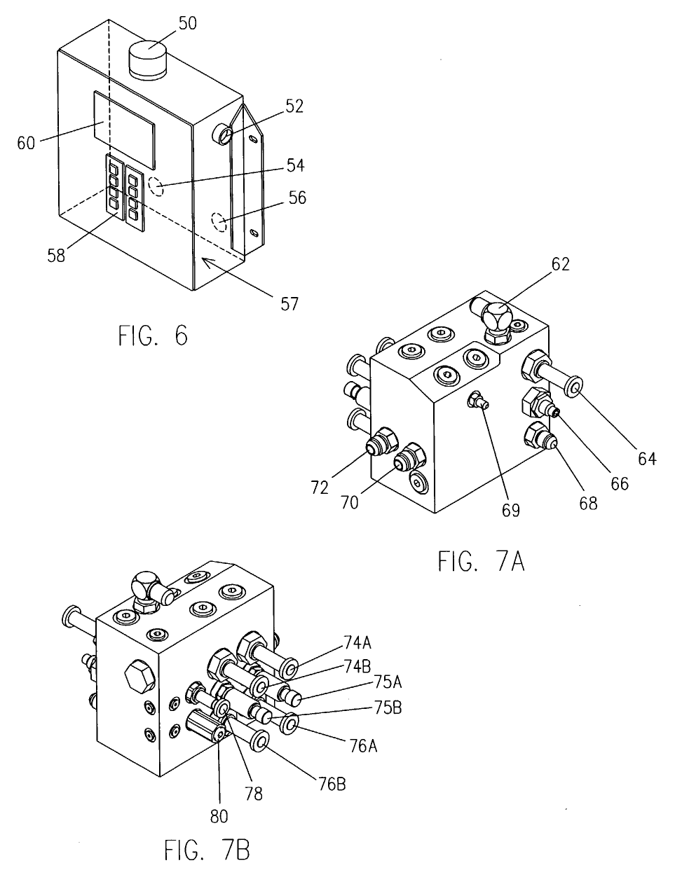

FIG. 6 shows an isometric view of the control panel.

FIGS. 7A and 7B show two different isometric views of the hydraulic manifold.

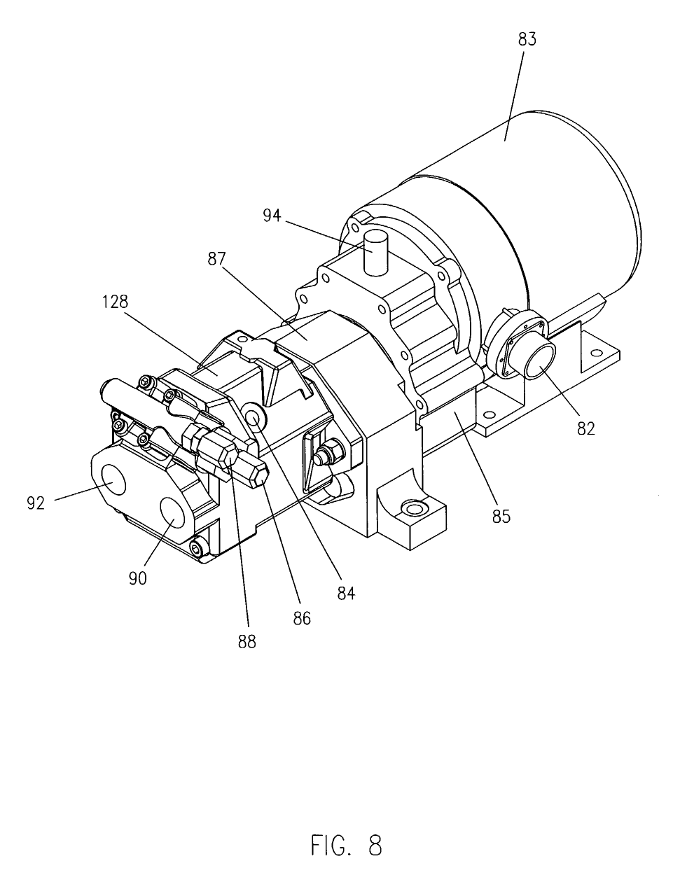

FIG. 8 shows an isometric view of the hydraulic pump & motor assembly.

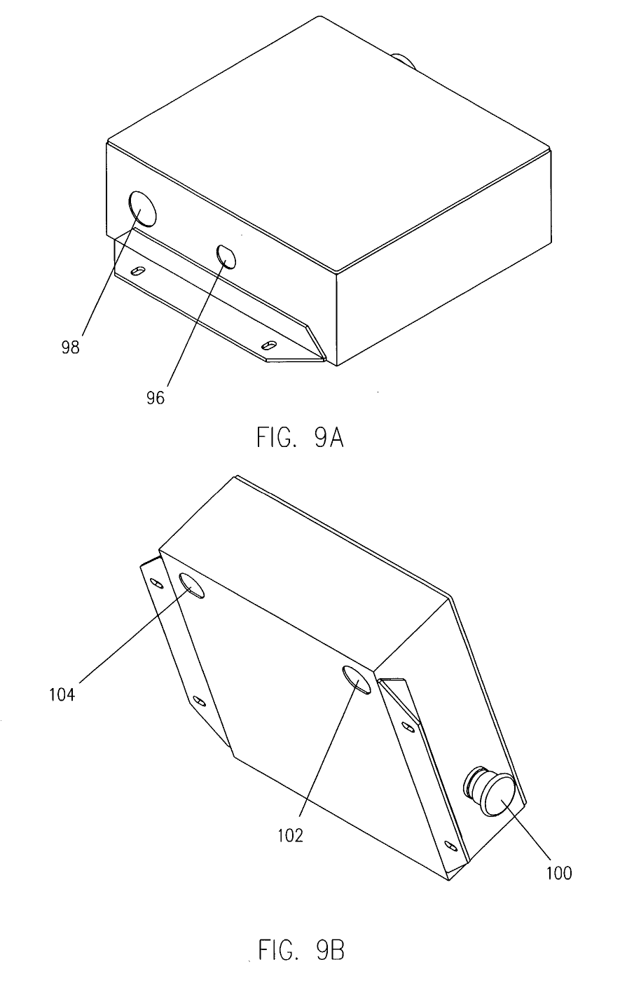

FIGS. 9A and 9B show two different isometric views of the main power enclosure.

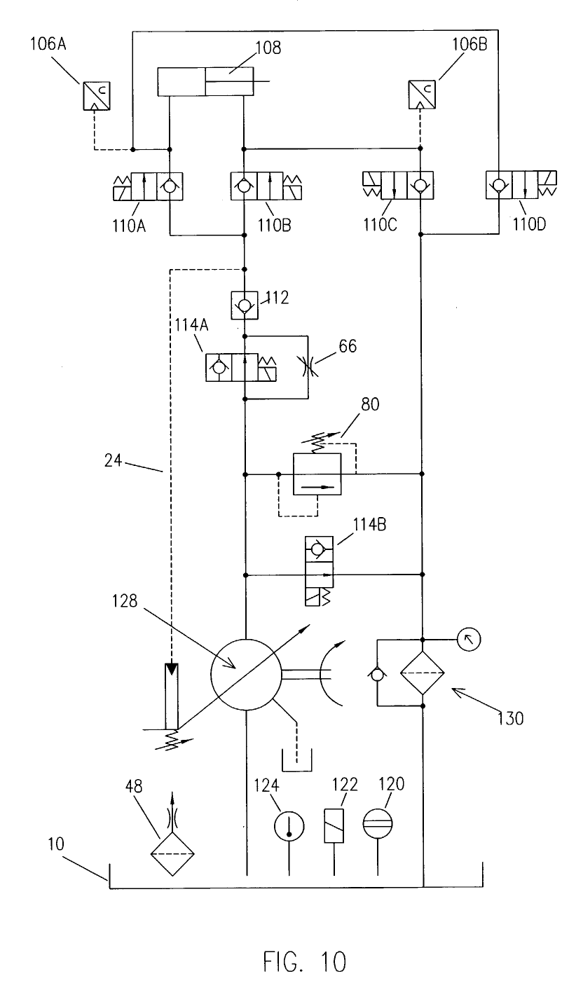

FIG. 10 shows a hydraulic schematic of a preferred embodiment of the present invention.

### REFERENCE NUMERALS IN DRAWINGS

2 Main Power Enclosure

4 Control Panel

6 Hydraulic Pump & Motor Assembly

8 Hydraulic Manifold

10 Hydraulic Fluid Reservoir

12 Electric Junction Enclosure

14 Support Structure

20 Hydraulic Fluid Return Line

22 Case Drain Line

24 Load Sense Line

26 Suction Line

28 Primary Electronic Junction Enclosure Connectors

30 Main Electrical Input Port

32 Additional Electronic Junction Enclosure Connectors

34 Hydraulic Fluid Filter Cap

36 Return Line Filter Input

38 Clog Filter Gauge

40 Suction Connector

42 Magnetic Plug Port

44 Sight Level Gauge

46 Case Drain Return Port

48 Hydraulic Reservoir Vent

50 Emergency Shutdown Indicator

52 Programming and Remote Control Port

54 Control Panel Main Electrical Output

56 Control Panel Main Electrical Input

57 Computer

58 Control Panel Input Device

60 LCD Screen

62 Return Line Port

64 Load Sense Solenoid

66 Load Sense Flow Rate Regulator

68 Main Hydraulic Pressure Input

69 Load Sense Port

70 Primary Hydraulic Power Transmission Line

72 Alternate Hydraulic Power Transmission Line

74A Directional Control Solenoid

74B Directional Control Solenoid

75A Pressure Transducer

75B Pressure Transducer

76A Directional Control Solenoid

76B Directional Control Solenoid

78 Soft Start Solenoid

80 Pressure Relief Valve

82 Main AC Electrical Port

83 Electric Motor

84 Case Drain Port

85 Gearbox

86 Compensator Adjustment

87 Hydraulic Adapter Block

88 Load Sense Connector

90 Suction Port

92 Hydraulic Pressure Port

94 Gearbox Breather Vent

96 Main DC Power Input

98 Main AC power and External Control Input

100 Emergency Stop and On/Off Button

102 Main AC Power Output

104 Main D-C Power Output

106A Pressure Transducer

106B Pressure Transducer

108 Work Member

110A Normally Closed Solenoid Operated One Way Check Valve

110B Normally Closed Solenoid Operated One Way Check Valve

110C Normally Closed Solenoid Operated One Way Check Valve

110D Normally Closed Solenoid Operated One Way Check Valve

112 One Way Check Valve

114A Normally Open Solenoid Operated One Way Check Valve

114B Normally Open Solenoid Operated One Way Check Valve

120 Fluid Level Meter

122 Normally Closed Level Switch

124 Thermometer

128 Variable Displacement Pump

130 Hydraulic Fluid Filter

### DETAILED DESCRIPTION

### Description—FIGS. 1 and 2—Preferred Embodiment

A preferred embodiment of the present invention is illustrated in FIG. 1 (an isometric view of the entire embodiment) and FIG. 2 (isometric view of entire embodiment with top components removed).

2 shows the main power enclosure, which is responsible for distribution and regulation of electric power, distribution of control (both input and output), and power protection of the said invention. Said main power enclosure is further detailed in FIGS. 9A and 9B.

Control panel 4 contains computer 57, which is the primary source of control, driven by either user or by remote input. Control panel 4 is further detailed in FIG. 6.

Hydraulic pump & motor assembly 6 uses the controlled electrical power from main power enclosure 2 and converts it to hydraulic power. It's activation and operation is controlled by signals from the computer 57 within control panel 4. The hydraulic pump & motor assembly 6 is further detailed in FIG. 8.

Hydraulic manifold 8 is responsible for distribution and monitoring of hydraulic power and is controlled by computer 57 within control panel 6. FIGS. 1 and 2 show hydraulic manifold 8 with solenoid coils in place. The hydraulic manifold 8 is further detailed in FIGS. 7A and 7B, with the solenoid coils removed for clarity.

Hydraulic fluid reservoir 10 contains the hydraulic fluid, filters foreign matter, and acts as an allocation point for hydraulic fluid. The hydraulic fluid reservoir is further detailed in FIG. 4.

Electric junction enclosure 12 is responsible for the fusing of the control lines from the control panel 4 and acts as a junction point for the monitoring of hydraulic power from the hydraulic manifold, 8. Electric junction enclosure 12 is further detailed in FIGS. 3A and 3B.

Support stucture 14 acts as a means to interlink all components of the present invention, so as to allow the present invention to remain portable. Support structure 14 also serves as a means to fasten the present invention to it's surroundings and acts as a rigid, durable support member. FIG. 5 shows support structure 14 with all other components removed.

Hydraulic fluid return line 20 acts as a means to return hydraulic fluid used in the hydraulic power generation process to the hydraulic fluid reservoir 10. It connects the return line port 62 to the return line filter input, 36 so as to filter the hyraulic fluid before it re-enters the hydraulic fluid reservoir 10.

Case drain line 22 acts as a means to allow fluid which has escaped into the case of the variable displacement pump, 128, back to the case drain return port, 46.

Load sense line 24 connects the load sense connector 88 to the load sense port 69. Said load sense line acts as a means to control the displacement of the variable displacement pump 128.

Suction line 28 connects the suction port 90 to the suction connector 40 and acts as a means to transport hydraulic fluid from the hydraulic fluid reservoir 10, to the variable displacement pump 128 to be converted to hydraulic power.

### FIGS. 3A and 3B

Primary electronic junction enclosure connectors 28 are connected to the hydraulic manifold 8, fused inside the electronic junction enclosure 12, and then further routed to the main electrical input port 30, which connects to the control panel main electrical ouput 54. Primary electronic junction enclosure connectors 28 and main electrical input port 30 facilitate communications between the hydraulic manifold 8 and computer 57 within control panel 4.

Additional electronic junction enclosure connectors 32 connect sight level gauge 44 to main electrical input port 30, and further connect to control panel main electrical output 54. This facilitates communication between hydraulic fluid reservoir 10 and computer 57 within control panel 4.

### FIG. 4

Hydraulic fluid filter cap 34 acts as a seal to hydraulic fluid filter 130.

Return line filter input 36 connects to hydraulic fluid return line 20 and acts as a means to direct hydraulic fluid to be filtered before re-entering hydraulic fluid reservoir 10.

Clog filter gauge 38 monitors the internal pressure of hydraulic fluid filter 130.

Suction connector 40 connects to suction line 28 and acts as a means to transport hydraulic fluid to suction port 90.

Magnetic plug port 42 contains a magnet which acts as a means to collect and allow removal of metal contaminants. Magnetic plug port 42 also acts as a means to allow drainage of the hydraulic fluid in the present invention.

Sight level gauge 44, which contains normally closed level switch 122 and fluid level meter 120, acts as a means to monitor hydraulic fluid level of the hydraulic fluid reservoir 10 and allows the user to visually inspect this level. Normally closed level switch 122 is connected to additional electronic junction enclosure connectors 32, then further connected to main electrical input port 30, and finally connected to control panel main electrical output 54. This facilitates communications of fluid level between sight level gauge 44 and computer 57 within control panel 4.

Case drain return port 46 is connected to case drain line 22 and allows hydraulic fluid which has escaped from the case of variable displacement pump 128 to return to hydraulic fluid reservoir 10.

The hydraulic reservoir vent 48 acts as a means to maintain pressure equilibrium between the atmosphere and the interior of hydraulic fluid reservoir 10.

### FIG. 6

Emergency shutdown indicator 50 is connected to control panel 4 and acts as a means to indicate to the user of the present invention that a critical error has occurred.

Programming and remote control port 52 acts both as a interface to allow programming of control panel 4 and as a means to allow an interface with a remote control input device.

Control panel main electrical output 54 is connected to main electrical input port 30.

Control panel main electrical input 56 is connected to main DC power output 102.

Computer 57 is the main source of control for the present invention. It controls all electical outputs, including electric motor 83, directional control solenoids 74A, 74B, 76A, 76B, soft start solenoid 78, load sense solenoid 64 and emergency shutdown indicator 50. It also controls all electrical inputs, including pressure transducers 75A and 75B, sight level gauge 44, main AC power and external control input 98 and control panel input device 58. Finally, the computer 57 monitors time.

Control panel input device 58 acts as a means to allow user input directly on control panel 4.

LCD screen 60 is an output device that provides feedback to the user of the present invention.

### FIGS. 7A and 7B

Return line port 62 is connected to hydraulic fluid return line 20 and provides a means for hydraulic fluid to return from hydraulic manifold 8 to hydraulic fluid reservoir 10.

Load sense solenoid 64 is controlled by computer 57 within control panel 4 and provides a means for adjusting the displacement of the variable displacement pump 128. This is further explained in the description of FIG. 10.

Load sense flow rate regulator 66 adjusts the displacement of the variable displacement pump when load sense solenoid 64 is active.

Main hydraulic pressure input 68 is connected to hydraulic pressure port 92.

Primary hydraulic power transmission line 70 and alternate hydraulic power transmission line 72 provide a means to transfer hydraulic power from the present invention to external hydraulic powered device.

Directional control solenoids 74A and 74B direct hydraulic pressure to either primary hydraulic power transmission line 70 or alternate hydraulic power transmission line 72.

Pressure transducers 75A and 75B monitor hydraulic pressure and communicate with computer 57 within control panel 4.

Directional control solenoids 76A and 76B direct return line port 62 to either primary hydraulic power transmission line 70 or alternate hydraulic power transmission line 72.

Soft start solenoid 78 controls whether hydraulic fluid is directed back to hydraulic fluid reservoir 10, or directed to directional control solenoids 74A and 74B.

Pressure relief valve 80 prevents hydraulic pressure from exceeding a preset limit by returning excess pressure to hydraulic fluid reservoir 10.

### FIG. 8

Main AC electrical port 82 is connected to main AC power output 102,

Electric motor 83 has it's speed reduced by gearbox 85 to drive variable displacement pump 28.

Case drain port 84 is connected to case drain line 22.

Compensator adjustment 86 limits the maximum hydraulic pressure variable displacement pump 128 can attain.

Hydraulic adapter block 87 acts as a means to fasten electric motor 83 and variable displacement pump 128 to support structure 14.

Load sense connector 88 is connected to load sense line 24 and adjusts the displacement of the variable displacement pump when load sense solenoid 64 is active.

Suction port 90 is connected to suction line 26.

Hydraulic pressure port 92 is connected to main hydraulic pressure input 68.

Gearbox breather vent 94 maintains pressure equilibrium within gearbox 85.

### FIGS. 9A and 9B

Main DC power input 96 is connected to an external DC power source.

Main AC power and external control input 98 is connected to an external AC power source, as well as to an external input device if required.

Emergency stop and on/off button 100 is used to both power the present invention on or off, as well as power present invention down in emergency situations.

Main AC power output 102 provides controlled AC power to main AC electrical port 82 of electric motor 83.

Main DC power ouput 104 provides DC power to control panel 4.

### FIG. 10

Hydraulic fluid reservoir 10 acts as a means to contain the hydraulic fluid of the present invention, and houses hydraulic reservoir vent 48, thermometer 124, normally closed level switch 122, and fluid level meter 120.

Variable displacement pump 128 is a hydraulic pump driven by electric motor 83, which is controlled by computer 57 within control panel 4 that generates hydraulic pressure for the present invention. This hydraulic pressure is further directed according to the specification of the present invention.

Normally open solenoid operated one way check valve 114B in tandem with soft start solenoid 78—which is controlled by computer 57 within control panel 4—provides a means for hydraulic fluid to either return to hydraulic fluid reservoir 10 or create hydraulic pressure further within the system. This allows for a soft start—a feature that provides a means for the electric motor 83 to obtain a high rotational speed without load being present, which reduces power consumption during motor startup. Activating soft start solenoid 78 closes normally open solenoid operated one way check valve 114B, thereby creating pressure further within the system.

Pressure relief valve 80 prevents hydraulic pressure from exceeding a preset value by allowing excess hydraulic pressure from variable displacement pump 128 to return to hydraulic reservoir 10.

Normally open solenoid operated one way check valve 114A is controlled by load sense solenoid 64—which is activated by computer 57 within control panel 4—which provides a means for multiple hydraulic flow rates to be selected. This allows for load sense, a feature which provides a means to conserve power and to speed up or slow down flow rate as required. When normally open solenoid operated one way check valve 114A is closed by activating load sense solenoid 64, flow is directed to load sense flow rate regulator 66, which is adjusted to alter the amount of restriction during load sense. This creates a pressure differential between the output of hydraulic pressure port 92 and load sense line 24. This pressure differential is detected by load sense connector 88, which in turn acts to alter the displacement of the variable displacement pump 128.

One way check valve 112 prevents hydraulic pressure returning from work member 128 to hydraulic pressure port 92. This maintains working hydraulic pressure when variable displacement pump 128 is not active.

By activating directional control solenoid 74A normally closed solenoid operated one way check valve 110A is opened and hydraulic pressure is connected to alternate hydraulic power transmission line 72. By activating directional control solenoid 74B normally closed solenoid operated one way check valve 110B is opened and hydraulic pressure is connected to primary hydraulic power transmission line 70. By activating directional control solenoid 76A normally closed solenoid operated one way check valve 110C is opened and hydraulic fluid from alternate hydraulic power transmission line 72 is connected to return line port 62. By activating directional control solenoid 76B normally closed solenoid operated one way check valve 110D is opened and hydraulic fluid from primary hydraulic power transmission line 70 is connected to return line port 62. The combination of normally closed solenoid operated one way check valves 110A, 110B, 110C and 110D provide a means to completely control the direction of hydraulic pressure output to working member 108 and hydraulic fluid returned from working member 108.

Pressure transducers 106A and 106B monitor and communicate with computer 57 within control panel 4 the hydraulic pressure output by primary hydraulic power transmission line 70 and alternate hydraulic power transmision line 72.

Working member 108 can be any device that consumes hydraulic power.

Hydraulic fluid filter 130 filters return hydraulic fluid from either normally closed solenoid operated one way check valve 110C, normally closed solenoid operated one way check valve 110D, pressure relief valve 80, or normally open solenoid operated one way check valve 114B.

### Additional Embodiments of Present Invention

There are many possible variations of the present invention possible other than the describe preferred embodiment. These include but are not limited to:

(a) different variety of motor

(b) different variety of pump

(c) plurality of motors

(d) plurality of pumps

(e) fire suppression means

(f) waste collection

(g) different sources of electrical power

(h) modified output means

(i) plurality of computers

(j) plurality of input means

(k) plurality of control valves

I claim:

1. A portable hydraulic power generation system comprised of a programmable and customizeable computer with means of monitoring all preferred measurable parameters of said hydraulic power generation system, a pump, a power generating device connected to said pump so as to drive said pump under control of said computer, providing a means to allow a plurality of user inputs to be managed by said computer to control a plurality of outputs, said outputs providing power to a connected plurality of work members.

2. The portable hydraulic power generation system of claim 1 wherein said power generating device is constantly running and immediately able to drive said pump.

3. The portable hydraulic power generation system of claim 2, wherein a fire suppression means is attached to said portable hydraulic power generation system.

4. The portable hydraulic power generation system of claim 2, wherein a waste collection device is attached to said portable hydraulic power generation system.

5. The portable hydraulic power generation system of claim 1, wherein said power generating device only runs when required.

6. The portable hydraulic power generation system of claim 5, wherein a fire suppression means is attached to said portable hydraulic power generation system.

7. The portable hydraulic power generation system of claim 5, wherein a waste collection device is attached to said portable hydraulic power generation system.

8. A portable hydraulic power generation system comprised of a programmable and customizeable computer with means of monitoring all preferred measurable parameters of said hydraulic power generation system, a plurality of pumps, a plurality of power generating devices connected to said pumps so as to drive said pumps under control of said computer, providing a means to allow a plurality of user inputs to be managed by said computer to control a plurality of outputs, said outputs providing power to a connected plurality of work members.

9. The portable hydraulic power generation system of claim 8, wherein said plurality of power generating devices are constantly running and immediately able to drive said plurality of pumps.

10. The portable hydraulic power generation system of claim 9, wherein a fire suppression means is attached to said portable hydraulic power generation system.

11. The portable hydraulic power generation system of claim 9, wherein a waste collection device is attached to said portable hydraulic power generation system.

12. The portable hydraulic power generation system of claim 8, wherein said plurality of power generating devices only run when required.

13. The portable hydraulic power generation system of claim 12, wherein a fire suppression means is attached to said portable hydraulic power generation system.

14. The portable hydraulic power generation system of claim 12, wherein a waste collection device is attached to said portable hydraulic power generation system.
